(19) United States
(12) Patent Application Publication
(10) Pub. No.: US 2026/0368342 A1
(43) Pub. Date: Nov. 19, 2026

(54) PROVIDING IMPROVED FILE SECURITY USING LARGE LANGUAGE MODEL PREDICTIONS

(71) Applicant: Proofpoint, Inc., Sunnyvale, CA (US)

(72) Inventors: Karl Felix Joehnk, Singapore (SG); Eliott Paul Andre Joulot, Paris (FR)

(21) Appl. No.: 19/207,643

(22) Filed: May 14, 2025

(51) Int. Cl. G06F 21/62; G06F 16/16

(52) U.S. Cl. CPC G06F 21/62; G06F 16/16

(57) ABSTRACT

Aspects related to providing improved file security using large language models are provided. A prediction platform may receive historical clustering information and predefined file categories. The platform may train a clustering algorithm to perform unsupervised file clustering. The platform may receive files. The platform may identify a sample set of files. The platform may train a categorization model to generate predicted custom categories for files. The categorization model may be a large language model. The platform may generate clusters of files. The platform may generate a predicted custom category summarizing a set of categorization predictions for a cluster of files. The platform may cause one or more policy updates based on the predicted custom category.

### TECHNICAL FIELD

Aspects of the disclosure relate to computer software and hardware for providing improved file security using large language models. In particular, one or more aspects of the disclosure relate to utilizing prompt engineering to improve large language models in order to generate customized file categorization predictions.

### BACKGROUND

Aspects described herein are related to providing improved file security using large language models. In some examples, organizations utilize services and/or programs that classify various types of files. Security measures such as data loss prevention (DLP) rules, packet filtering rules, and the like are applied to files based on the classifications. In conventional systems, files are classified using pre-defined, out-of-the-box (OOB) categories provided by a service and/or program. Increasingly, as the needs of clients diversify and the number of different formats, contents, and other attributes of files increases, there exists a need for a system to dynamically and efficiently provide new and/or customized categories beyond the conventional OOB categories in order to accurately classify files. Without such a system there is an increased risk of files being categorized inaccurately, which also leads to inaccurate or less efficient application of security measures. Additionally, providing custom categories to clients with large quantities of information can be costly and inefficient, so there exists a need for an efficient means of providing custom categories for files in such systems.

### SUMMARY

Aspects of the disclosure provide effective, efficient, scalable, secure, and convenient technical solutions that address and overcome the technical problems associated with current methods of providing security based on file classification/categorization. For example, one or more aspects of the disclosure relate to providing improved file security using large language models.

In accordance with one or more arrangements of the disclosure, a computing platform with at least one processor, a communication interface, and memory storing computer-readable instructions may receive historical clustering information and a plurality of predefined file categories. The computing platform may configure, based on embeddings associated with the historical clustering information, a clustering algorithm to perform unsupervised clustering of files. The computing platform may identify a sample set of files. The computing platform may identify the sample set of files based on a predetermined sample threshold. The sample set of files may include a number of files, of a plurality of files, that meets or exceeds the predetermined sample threshold. The computing platform may generate, by generating a plurality of embeddings of the sample set of files and using the clustering algorithm, one or more clusters of files. The computing platform may generate, based on the one or more clusters of files, a predicted custom category, wherein the predicted custom category comprises a category name summarizing the one or more clusters of files. The computing platform may output the predicted custom category.

In one or more examples, the computing platform may configure a categorization model. Configuring the categorization model may include providing, to the categorization model, one or more training sets of information corresponding to file categorization. Configuring the categorization model may further include causing, based on the one or more training sets, the categorization model to categorize files using at least one category name different from the plurality of predefined file categories. The categorization model may be used to generate the predicted custom category. The categorization model may comprise a large language model.

In one or more arrangements, the computing platform may cause one or more policy updates by outputting, to a security device, the predicted custom category. Outputting the predicted custom category may cause the security device to update one or more data loss prevention cybersecurity rules. In one or more examples, the computing platform may cause the one or more policy updates by causing one or more devices to update the plurality of predefined file categories to include the predicted custom category, based on the output of the predicted custom category.

In one or more arrangements, the computing platform may receive feedback information corresponding to the predicted custom category. The computing platform may receive the feedback information based on the output of the predicted custom category and from one or more devices. The computing platform may update, based on the feedback information, one or more of: the clustering algorithm and a categorization model. In one or more examples, the computing platform may cause display of a feedback interface based on the output of the predicted custom category. The feedback information may be received based on user input responsive to the display of the feedback interface.

In one or more arrangements, the computing platform may configure the clustering algorithm by providing the clustering algorithm with a cluster size parameter defining a minimum cluster size and a maximum cluster size. The computing platform may configure the clustering algorithm by providing the clustering algorithm with a distance parameter. The distance parameter may comprise a maximum semantic difference allowed between any two files to be clustered together by the clustering algorithm.

In one or more examples, the computing platform may identify, based on the historical clustering information, one or more inconsistent clusters. The computing platform may identify the sample set of files further based on the one or more inconsistent clusters. In one or more arrangements, the computing platform may generate, based on inputting the plurality of embeddings into the clustering algorithm, a set of categorization predictions. Each categorization prediction may include a category name for a corresponding file of the sample set of files. The computing platform may cluster, based on performing hierarchical aggregation and based on the set of categorization predictions, files of the sample set of files into the one or more clusters. In one or more examples, the computing platform may generate, using the categorization model, a description corresponding to the predicted custom category. The computing platform may output the description.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for providing improved file security using large language models in accordance with one or more example arrangements;

FIGS. 2A-2F depict an illustrative event sequence for providing improved file security using large language models in accordance with one or more example arrangements;

FIG. 3 depicts an illustrative representation of a hierarchical aggregation of files based on file clustering parameters for providing improved file security using large language models in accordance with one or more example arrangements.

FIG. 4 depicts an illustrative graphical user interface generated as part of providing improved file security using large language models in accordance with one or more example arrangements; and

FIGS. 5A-5B depict an illustrative method for providing improved file security using large language models in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further below, one or more aspects described herein are related to systems and methods for providing improved file security using large language models. As described in the background above, in conventional systems, files are classified using pre-defined OOB categories provided by a service and/or program. However, these OOB categories may be insufficient to accurately classify all files used by various clients of an organization. Inaccurate classification of files increases the difficulty of applying the proper security measures to protect the information included in the files. This problem is magnified in systems which possess large quantities of information. Therefore, there exists a need for an efficient and scalable solution to providing file security using file classification.

Accordingly, in some instances, entities such as an organization (e.g., a provider of file classification services or programs, and/or other organizations/institutions) may deploy, maintain, and/or otherwise utilize a prediction platform leveraging large language model techniques as described herein to provide improvements to the security, reliability, and scalability of file classification systems, particularly in a system that possesses large quantities of information that can be processed using a large language model. Additionally, the features described herein such as generating clusters of files based on embeddings (e.g., as described at step 207 below), and identifying sampling points in clusters (e.g., as described at step 210 below), offer improvements to conventional large language models by circumventing scalability issues associated with the use of such models. For example, by performing prompt engineering techniques such as those described herein a large language model may be used to analyze sample points in a cluster rather than the entire cluster, offering improvements to scalability and efficiency in environments where a large language model is unable to process all of the information or files present in the environment. The prediction platform utilizes the large language models to generate predictions of categories, beyond the OOB options, that might be applied to certain files. These predictions may be used to provide customized categories to clients of the organization, improving both the client experience and the efficacy of security measures applied based on the categorization of files.

A prediction platform as described herein may perform predictions for customized categories to be applied to certain files. The prediction platform may receive a plurality of different files having different formats (e.g., text documents, portable document formats, video files, audio files, and the like) and/or different contents (e.g., administrative information, financial information, information pertaining to legal matters, and/or other types of information) and a plurality of pre-defined (e.g., OOB) categories for files. The prediction platform may generate embeddings of each file and the predefined categories. The prediction platform may use the embeddings to generate clusters of files based on various parameters (e.g., minimum cluster size, amount/percentage of similarity between the embeddings of the files, and/or other parameters). The prediction platform may identify inconsistencies in the clusters relative to historical clustering information, where said inconsistencies indicate that a categorization applied to certain files in the past might not have been accurate. The prediction platform may utilize a sample set of files from the files identified as having inconsistencies to generate new categorizations for each sample file in the sample set. The prediction platform may then generate custom category embeddings for each sample file of the sample set of files and, based on the embeddings, generate a predicted custom category (including the custom category embeddings) into which the sample files should be clustered. The predicted custom category (including the clustered custom category embeddings) may be used to provide a number of benefits, such as improved security by updating security rules based on the custom category, providing a more robust offering of OOB categories by updating a list of OOB categories to include the custom category, and/or other benefits described herein.

In some examples, in performing the methods of deploying and/or utilizing the prediction platform as described herein, the prediction platform may train and/or configure one or more machine learning models. For example, the prediction platform may configure a large language model, based on prompt engineering (e.g., by providing prompts with information such as context, inputs, or examples of historical clustering/classification of files and/or of embeddings as described herein), to perform the open (e.g., freestyle) categorization predictions for sample sets of inconsistent files, and/or to generate predicted custom categories based on the clustered custom category embeddings. Additionally or alternatively, the prediction platform may train the large language model based on one or more large language model training sets derived from a number of sources (e.g., third party sources, the Internet, and/or other sources).

These and various other aspects will be discussed more fully herein.

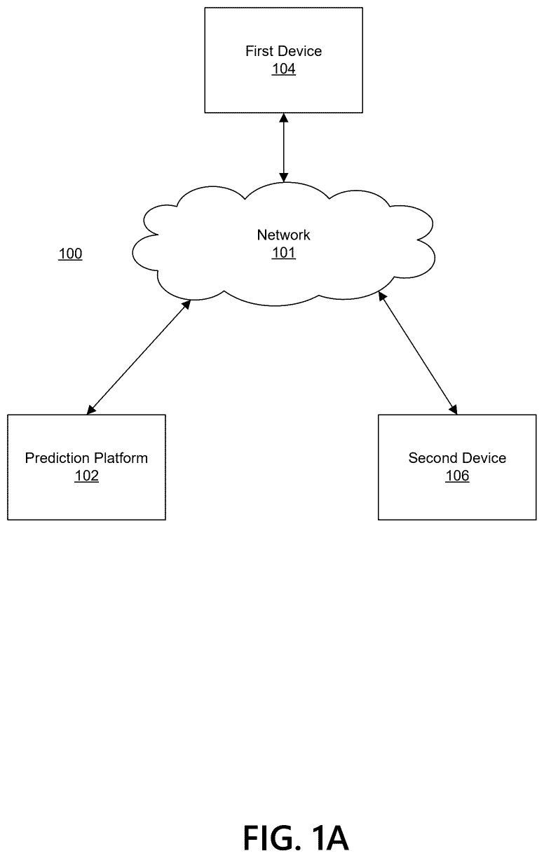

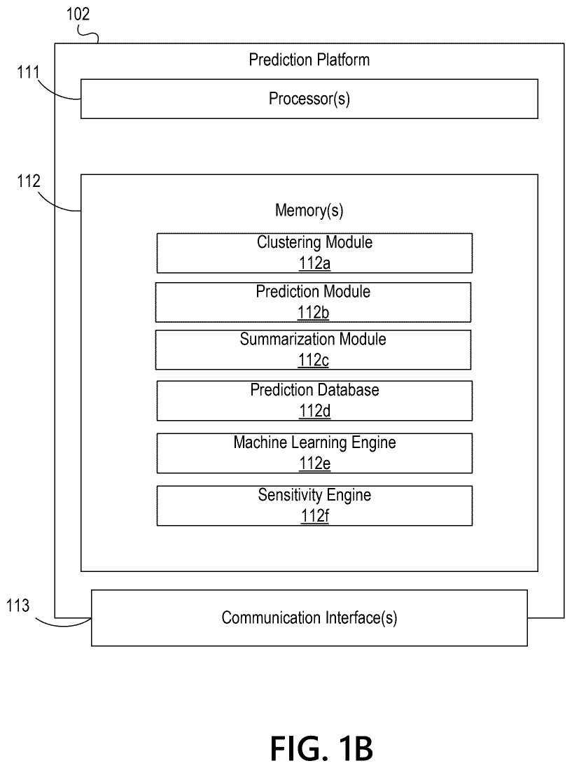

FIGS. 1A-1B depict an illustrative computing environment for providing improved file security using large language models in accordance with one or more example arrangements. Referring to FIG. 1A, computing environment 100 may include one or more computer systems. For example, computing environment 100 may include a prediction platform 102, a first device 104, a second device 106, and/or other computer systems.

As described further below, prediction platform 102 may be a computer system that includes one or more computing devices (e.g., servers, laptop computer, desktop computer, mobile device, and/or other devices) and/or other computer components (e.g., processors, memories, communication interfaces) that may be used to configure, train, and/or execute one or more machine learning models (e.g., a large language model, such as a large language model configured to perform techniques for providing improved file security, and/or an unsupervised clustering model/algorithm configured to perform unsupervised file clustering). For example, the prediction platform 102 may train or otherwise configure (e.g., based on prompt engineering) a large language model to perform open/freestyle categorization of files, to predict custom categories, and/or to perform other functions described herein. The prediction platform 102 may additionally or alternatively train (at least initially) an unsupervised clustering algorithm to perform unsupervised clustering of files based on input of embeddings of files. For example, the prediction platform 102 may train the unsupervised clustering algorithm to perform unsupervised clustering based on one or more clustering parameters described herein. The prediction platform 102 may be managed by and/or otherwise associated with an organization (e.g., an organization or institution providing file classification services and/or programs, and/or other organizations/institutions) that may, e.g., be associated with one or more additional systems (e.g., first device 104, second device 106, and/or other systems). In one or more instances, the prediction platform 102 may be configured to communicate with one or more systems (e.g., first device 104, second device 106, and/or other systems) to perform an information transfer, train and/or configure large language models, update security rules, cause display of a user interface, update a list of predefined file categories, and/or perform other functions.

The first device 104 may be a computing device (e.g., laptop computer, desktop computer, mobile device, tablet, smartphone, neural link device, virtual reality access device, server, server blade, and/or other device) and/or other data storing or computing component (e.g., processors, memories, communication interfaces, databases) that may be used to transfer information (e.g., lists of predefined categories, files, and/or other information) between devices and/or perform other functions. In some examples, the first device 104 may be a device or system configured to be used by an individual who may, e.g., be a client or customer of an organization affiliated with or otherwise receiving services from the prediction platform 102. For example, the individual may use the first device 104 to provide a plurality of files to be used as part of a service providing improved file security as described herein. In some instances, the first device 104 may be configured to display one or more graphical user interfaces (e.g., feedback interfaces, and/or other interfaces) which may, for example, enable the individual to provide feedback on predicted custom categories and/or perform other actions via the user interfaces. In some examples, the first device 104 may be an on-premises computing device.

The second device 106 may be a computing device (e.g., laptop computer, desktop computer, mobile device, tablet, smartphone, neural link device, virtual reality access device, server, server blade, and/or other device) and/or other data storing or computing component (e.g., processors, memories, communication interfaces, databases) that may be used to transfer information (e.g., predefined categories, predicted custom categories, and/or other information) between devices and/or perform other functions. In some examples, the second device 106 may be a device or system configured to be used by an individual who may, e.g., be an employee of an organization affiliated with or otherwise providing services via the prediction platform 102. For example, the individual may use the second device 106 to provide the predefined categories used, and improved on, by a service providing improved file security as described herein. In some instances, the second device 106 may be configured to display one or more graphical user interfaces (e.g., feedback interfaces, and/or other interfaces) which may, for example, enable the individual to provide feedback on predicted custom categories and/or perform other actions via the user interfaces. In some examples, the second device 106 may be a cloud-based computing device. The second device 106 may be located at a premises different from the premises of the prediction platform 102.

Computing environment 100 also may include one or more networks, which may interconnect prediction platform 102, first device 104, and second device 106. For example, computing environment 100 may include a network 101 (which may interconnect, e.g., prediction platform 102, first device 104, and second device 106). Network 101 may include one or more wired and/or one or more wireless networks that interconnect prediction platform 102, first device 104, and second device 106.

In one or more arrangements, prediction platform 102, first device 104, and second device 106 may be any type of computing device capable of sending and/or receiving requests and processing the requests accordingly. For example, prediction platform 102, first device 104, second device 106, and/or other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of prediction platform 102, first device 104, and second device 106 may, in some instances, be special-purpose computing devices configured to perform specific functions.

Referring to FIG. 1B, prediction platform 102 may include one or more processors 111, memory 112, and communication interface 113. A data bus may interconnect processors 111, memory 112, and communication interface 113. Processors 111 may control operations of the prediction platform 102. Communication interface 113 may be a network interface configured to support communication between prediction platform 102 and one or more networks (e.g., network 101, or the like), and communication interface 113 may enable prediction platform 102 to exchange information and/or otherwise communicate with one or more devices connected to such networks. Communication interface 113 may be communicatively coupled to the processors 111. Memory 112 may include one or more program modules having instructions that, when executed by processors 111, cause prediction platform 102 to perform one or more functions described herein, and/or one or more databases (e.g., a prediction database 112d, or the like) that may store and/or otherwise maintain information which may be used by such program modules and/or processors 111. In some instances, the one or more program modules and/or databases may be stored by and/or maintained in different memory units of prediction platform 102 and/or by different computing devices that may form and/or otherwise make up prediction platform 102. For example, memory 112 may have, host, store, and/or include a clustering module 112a, a prediction module 112b, a summarization module 112c, a prediction database 112d, a machine learning engine 112e, a sensitivity engine 112f, and/or other modules and/or databases.

Clustering module 112a may have instructions that direct and/or cause prediction platform 102 to perform an initial clustering of files received by the prediction platform 102. For example, clustering module 112a may have instructions that direct and/or cause the prediction platform 102 to receive predefined categories for file clustering, receive historical supervised clustering information, train an unsupervised clustering algorithm, receive files, generate embeddings of files, generate clusters of files, and/or perform other functions. Prediction module 112b may have instructions that direct and/or cause prediction platform 102 to identify inconsistencies in clusters of files, identify sample files, generate categorizations for sample files, and/or perform other functions. Summarization module 112c may have instructions that direct and/or cause the prediction platform 102 to summarize predicted categorizations into a predicted custom category. For example, summarization module 112c may have instructions that direct and/or cause the prediction platform 102 to generate custom category embeddings, generate predicted custom categories, update security rules, update lists of predefined categories, receive feedback, update classification algorithms and/or large language models, and/or perform other functions. Prediction database 112d may have instructions causing prediction platform 102 to store (e.g., in memory 112) correlations and/or information used to train and/or configure large language models, clusters of files, embeddings of files and/or of other information, and/or other information. Machine learning engine 112e may have instructions to train, implement, and/or update one or more machine learning models, such as a large language model, an unsupervised clustering algorithm, and/or other machine learning models. Sensitivity engine 112f may have instructions that direct and/or cause the prediction platform to perform a sensitivity assessment, to recommend one or more security updates, and/or to perform other functions. Although clustering module 112a, prediction module 112b, summarization module 112c, prediction database 112d, machine learning engine 112e, and sensitivity engine 112f are depicted as separate modules herein, the instructions stored by these modules may be stored in any number of modules without departing from the scope of this disclosure. For example, the instructions stored by clustering module 112a, prediction module 112b, summarization module 112c, machine learning engine 112e, and/or sensitivity engine 112f may be combined into the same module.

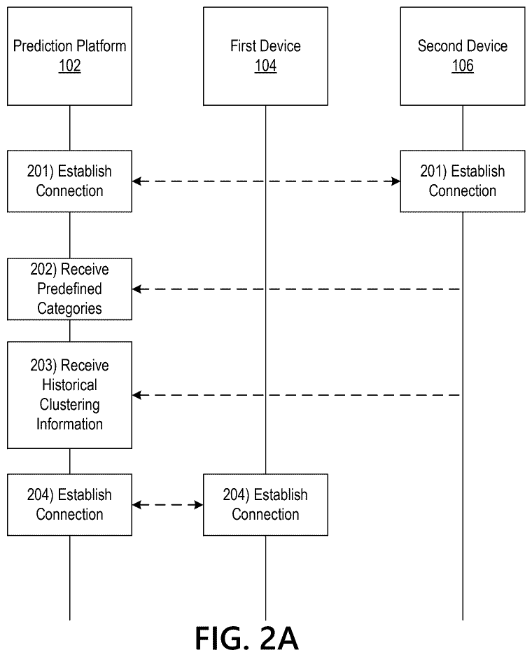

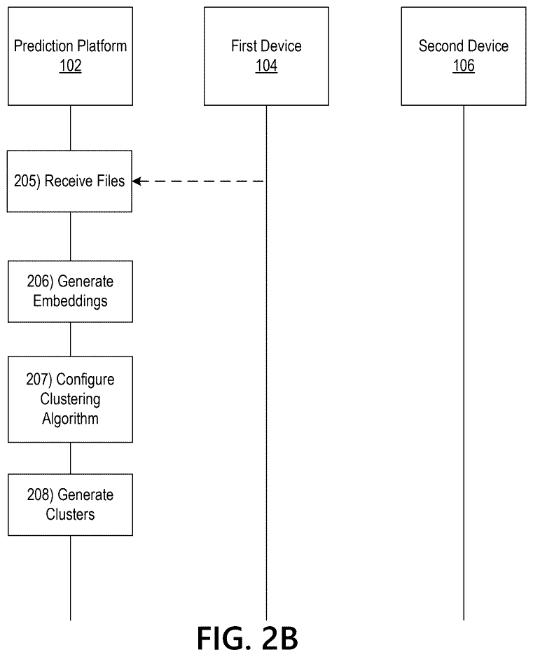

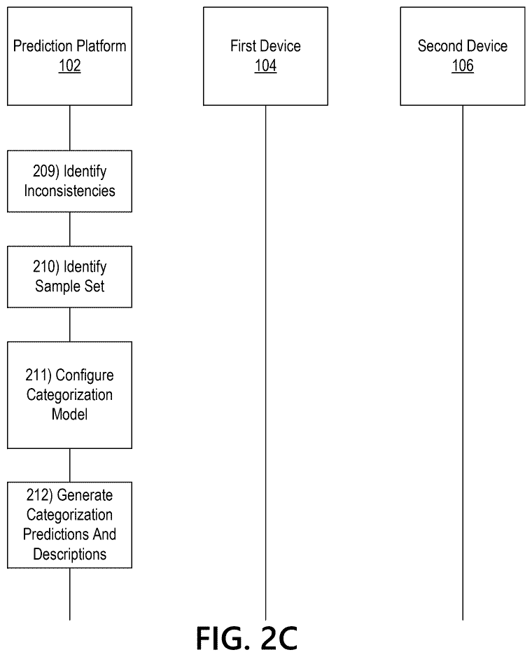

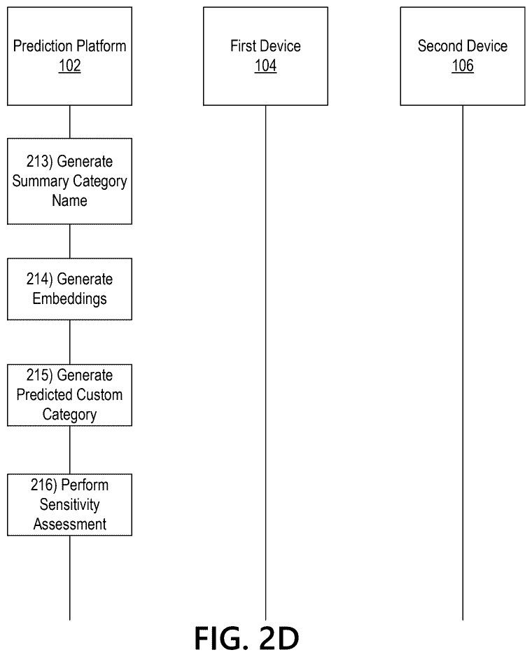

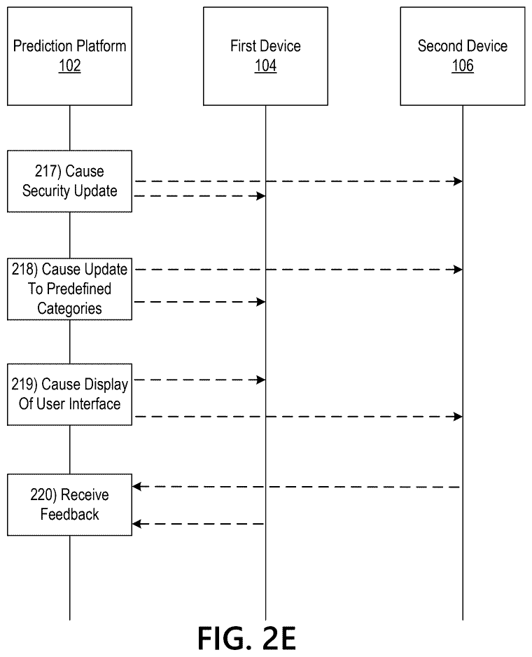

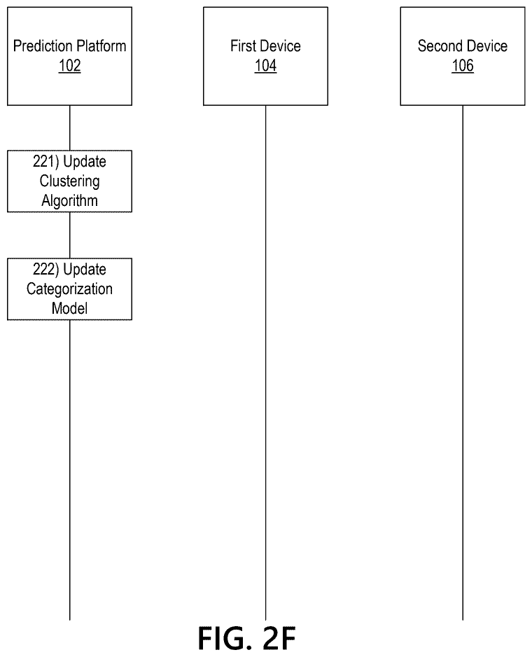

FIGS. 2A-2F depict an illustrative event sequence for providing improved file security using large language models in accordance with one or more example arrangements. Referring to FIG. 2A, at step 201, the prediction platform 102 may establish a connection with the second device 106. For example, the prediction platform 102 may establish a first wireless data connection with the second device 106 to link the second device 106 with the prediction platform 102 (e.g., in preparation for receiving predefined categories for file clusters, for receiving historical clustering information, and/or to perform other functions). In some instances, the prediction platform 102 may identify whether or not a connection is already established with the second device 106. If a connection is already established with the second device 106, the prediction platform 102 might not re-establish the connection. If a connection is not yet established with the second device 106, the prediction platform 102 may establish the first wireless data connection as described herein.

At step 202, the prediction platform 102 may receive a plurality of predefined file categories for file clustering. For example, the prediction platform 102 may receive the plurality of predefined file categories from the second device 106 via the communication interface 113 and while the first wireless data connection is established. Additionally or alternatively, in some examples, the prediction platform 102 may receive the plurality of predefined file categories from software and/or programs previously installed at the prediction platform 102 (e.g., in memory 112). For example, the prediction platform 102 may have a plurality of predefined OOB categories of files pre-installed in memory 112. The predefined file categories may include categories for classifying files based on type (e.g., text document, portable document format (PDF) documents, and/or other file types), content (e.g., administrative information, financial information, information pertaining to legal matters, and/or other types of information), and/or other categories. The predefined file categories may be supplied by an organization, such as the organization associated with the prediction platform 102.

At step 203, the prediction platform 102 may receive historical clustering information. For example, the prediction platform 102 may receive the historical clustering information from the second device 106 via the communication interface 113 and while the first wireless data connection is established. The historical clustering information may include historical clustering/classification information indicating categories assigned to historical clusters of files that were clustered using unsupervised techniques from a previous clustering run (e.g., as described herein at step 207) and/or historical clusters of files that were clustered previously using supervised clustering techniques (e.g., manual clustering, clustering using supervised machine learning algorithms, and/or other techniques). For example, the historical clustering information may indicate that certain files were clustered based on the predefined file categories received at step 202. In some examples, the historical clustering information may include embeddings (e.g., vectorized representations of the files converted into strings of numbers, bits, or other formats configured to be read by a machine learning model) of the files included in the historical clusters. In some examples, the historical clustering information may additionally include embeddings of the historical clustering/classification information. For example, the historical clustering information may include the historical clustering/classification information converted into a format configured to be analyzed and clustered by a clustering algorithm, as described below.

At step 204, the prediction platform 102 may establish a connection with the first device 104. For example, the prediction platform 102 may establish a second wireless data connection with the first device 104 to link the first device 104 with the prediction platform 102 (e.g., in preparation for receiving files, and/or to perform other functions). In some instances, the prediction platform 102 may identify whether or not a connection is already established with the first device 104. If a connection is already established with the first device 104, the prediction platform 102 might not re-establish the connection. If a connection is not yet established with the first device 104, the prediction platform 102 may establish the second wireless data connection as described herein.

Referring to FIG. 2B, at step 205, the prediction platform 102 may receive a plurality of files. For example, the prediction platform 102 may receive files from the first device 104 via the communication interface 113 and while the second wireless data connection is established. Additionally or alternatively, the prediction platform 102 may receive the files from one or more different devices. The files may be received via a folder, a link, an attachment to an electronic message, and/or via other methods. The files may include files corresponding to any number of topics/concepts (e.g., accounting documents, legal documents, administrative documents, and/or any other types of files). In some examples, the prediction platform 102 may receive the files without communicating with a device connected to network 101. For example, the prediction platform 102 may receive the files by way of an upload from a scanner or the like that is on-premises with the prediction platform 102 (e.g., using an internal network, such as a WiFi network, or the like). Additionally or alternatively, in some examples, the prediction platform 102 may receive the files as part of a request, from the first device 104, for the prediction platform 102 to categorize the files as part of a service provided by the entity associated with the prediction platform 102. The prediction platform 102 may receive the files for use in providing additional training information for a clustering algorithm as described herein.

At step 206, the prediction platform 102 may generate embeddings. For example, the prediction platform 102 may generate a plurality of embeddings, one embedding for each file of the plurality of files received at step 206. In generating the embeddings, the prediction platform 102 may convert each file into a format configured to be analyzed and clustered by the clustering algorithm. For example, the prediction platform 102 may vectorize each file to convert the file into a multidimensional vector representing the information included within the file. Generating the embeddings may cause the files to be converted into a format that represents the type of information included in the file. For example, a vector representing information included within a legal document may possess more similarities, in the vector space, with an embedding of another legal document than an embedding of, for example, an invoice. In this way, the embeddings generated by the prediction platform 102 may include information representing a semantic distance between any two files.

At step 207, the prediction platform 102 may select, program, initiate, and/or otherwise configure a clustering algorithm. For example, the prediction platform 102 may select, program, initiate, and/or otherwise configure, using the machine learning engine 112e and based on the historical clustering information and/or the clusters of files of step 207, the clustering algorithm to generate clusters of files based on input of embeddings of files. The prediction platform 102 may select, program, initiate, and/or otherwise configure the clustering algorithm by causing the clustering algorithm to process the historical clustering information using one or more unsupervised machine learning techniques. For example, the prediction platform 102 may cause the clustering algorithm to process the historical clustering information by applying unsupervised machine learning techniques such as principal component analysis, hierarchical clustering, K-means clustering, and/or other unsupervised techniques. By causing the clustering algorithm to process the historical clustering information, the prediction platform 102 may select, program, initiate, and/or otherwise configure the clustering algorithm to identify inconsistencies in clusters generated by the clustering algorithm based on using the historical clustering information as a benchmark or historical sample of how certain files, indicated by the historical clustering information, were clustered. In configuring the clustering algorithm, the prediction platform 102 may select, program, initiate, and/or otherwise configure the clustering algorithm to utilize one or more unsupervised techniques to perform unsupervised clustering to generate the clusters of files based on input of embeddings.

In some examples, in configuring the clustering algorithm to generate clusters of files based on input of embeddings of files, the prediction platform 102 may provide the clustering algorithm with one or more parameters to utilize while generating the clusters. The parameters may dictate the size of clusters generated by the clustering algorithm, a level of similarity required between files sharing a cluster, and/or other aspects of the clusters. For example, the prediction platform 102 may provide the clustering algorithm with a cluster size (and/or cluster density) parameter defining a minimum cluster size and/or a maximum cluster size. The cluster size parameter may control a number of files that the clustering algorithm is configured to include in clusters generated as described herein. Additionally or alternatively, the prediction platform 102 may provide the clustering algorithm with a distance parameter. The distance parameter may be and/or include a maximum semantic difference allowed between any two files sharing a cluster (e.g., any two files sharing a cluster, defined as cosine, Euclidean, or any other mathematical distance measure). For example, a distance parameter may require that a semantic distance (e.g., a value representing the relatedness or similarity between words, concepts, and/or other elements of the files) between files sharing a cluster be less than a threshold value (e.g., indicating that the files have a particular level of similarity). For example, the distance parameter may indicate a threshold of 60% similarity must be satisfied (i.e., that the semantic distance between any two files sharing a cluster be less than 0.4, or 40%). In some examples, the prediction platform 102 may configure the clustering algorithm to allow the clustering algorithm to generate clusters outside of the provided parameters while causing the clustering algorithm to indicate whether the provided parameters have not been met. For example, the clustering algorithm may be configured to generate clusters with any semantic distance between two files sharing a cluster, but to generate a notification or otherwise indicate which clusters include files having a distance that meets or exceeds the distance parameter. Additionally or alternatively, in some examples, configuring the clustering algorithm may comprise receiving, accessing, implementing, and/or otherwise utilizing an existing clustering algorithm.

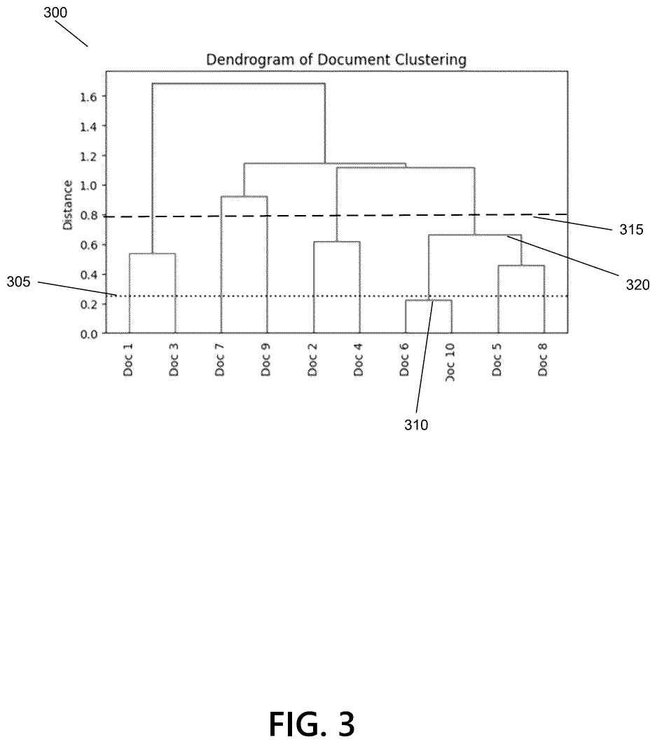

At step 208, the prediction platform 102 may generate clusters of files. To cluster the files, the prediction platform 102 may utilize one or more unsupervised learning techniques to cluster files based on a number of factors, such as a perceived similarity between the files and/or other factors. In some examples, the clustering algorithm may generate the clusters using parameters previously provided by the prediction platform 102, and/or parameters previously learned by the clustering algorithm using unsupervised self-learning techniques. For example, the clustering algorithm may generate the clusters based on a cluster size (and/or cluster density) parameter defining a minimum cluster size and/or a maximum cluster size as described herein. Additionally or alternatively, the clustering algorithm may generate the clusters based on a distance parameter as described herein. The distance parameter may be and/or include a maximum semantic difference allowed between any two embeddings of files sharing a cluster. Additionally or alternatively, the distance parameter may configure the clustering algorithm to generate a notification or otherwise indicate which clusters include embeddings of files having a distance that meets or exceeds the distance parameter. In some examples, the prediction platform 102 may generate clusters of files based on the parameters that may be visually represented by a dendrogram or other hierarchical structure, such as the illustrative representation of clustering based on parameters as shown in FIG. 3 (described further below).

Referring to FIG. 2C, at step 209, the prediction platform 102 may identify inconsistent clusters in the clusters generated at step 208. In some examples, in identifying the inconsistencies, the prediction platform 102 may compare the clusters generated by the clustering algorithm to the historical clustering information in order to identify files that have been clustered differently than the same files, and/or similar files, were historically clustered. In some examples, in identifying the inconsistencies, the prediction platform 102 may cause the clustering algorithm to identify inconsistencies by comparing the clusters to the historical clustering information (e.g., including prior classifications/clusters for the same and/or similar files) previously inputted to the clustering algorithm. In some examples, the clustering algorithm may identify the inconsistencies based on the configuring described herein at step 207. It should be understood that the identification of inconsistencies described herein may be automatically performed by the clustering algorithm in response to and/or as part of the process of generating the clusters. An inconsistent cluster may include one or more files that were previously classified with different files. For example, a file that was previously classified as an invoice file that is now clustered with five administrative files may be identified as an inconsistently clustered file (e.g., indicating that the file was inaccurately classified), and the cluster including the file may be identified as an inconsistent cluster. The prediction platform 102 may identify multiple inconsistent clusters in the manner described above.

At step 210, the prediction platform 102 may identify a sample set. For example, the prediction platform 102 may identify a sample set of clusters and/or files for use in generating predicted custom categories. The prediction platform 102 may identify the sample set by selecting, from the one or more inconsistent clusters, a number of files, and/or entire clusters of files to use as the sample set. In some examples, the prediction platform 102 may additionally or alternatively identify the sample set by selecting, from one or more consistent clusters, a number of files and/or entire clusters of files to use as the sample set. In this manner, the identified sample set may include one or more files from consistent clusters and one or more files from inconsistent clusters. The prediction platform 102 may identify the sample set based on a predetermined sample threshold. In some examples, the predetermined sample threshold may correspond to a number of files to include in a sample set. For example, the predetermined sample threshold may be three, and the prediction platform 102 may identify up to three inconsistent files within a plurality of inconsistent clusters or up to three consistent files such that the total number of consistent files and inconsistent files is three or less. In some examples, the prediction platform 102 may identify the sample set using a random selection. For example, the prediction platform 102 may randomly select a number of sample files that satisfies the predetermined sample threshold.

At step 211, the prediction platform 102 may train and/or otherwise configure a categorization model. For example, the prediction platform 102 may train and/or otherwise configure, using the machine learning engine 112e and based on one or more training sets of information, the categorization model to categorize files using different category names (e.g., using at least one category name different from the plurality of predefined file categories). In some instances, the training sets of information may be retrieved by the prediction platform 102 from different sources, such as a network (e.g., the Internet), a local database or other repository, and/or other sources. In some examples, the prediction platform 102 may receive the training sets of information from a user device, such as the first device 104 and/or the second device 106 (e.g., while the first wireless data connection is established or while the second wireless data connection is established, respectively). The training sets of information may include information corresponding to file categorization. For example, the training sets of information may include techniques, templates, instructions, or the like corresponding to different techniques for file categorization. The prediction platform 102 may train and/or otherwise configure the categorization model, based on the one or more training sets, to categorize files using category names different from the plurality of predefined categories (e.g., as described at step 202 herein). For example, the prediction platform 102 may train and/or otherwise configure the categorization model to output, based on input of sample files, categorization predictions including category names for each file. The prediction platform 102 may additionally train and/or otherwise configure the categorization model to output, based on input of (and/or based on using) embeddings of categorization predictions (e.g., an initial set of custom category names summarizing category names of sample files) previously generated by the categorization model, one or more predicted custom categories. A predicted custom category may include a single category name that summarizes a set of categorization predictions/initial set of custom category names that is provided as input to the categorization model.

In some examples, the categorization model may be a large language model. In these examples, the one or more training sets may include a volume of information sufficient to train a large language model and exceeding an amount of information that other machine learning models are capable of processing.

In some instances, to configure and/or otherwise train the categorization model, the prediction platform 102 may cause the categorization model to process the one or more training sets using one or more machine learning techniques. For example, the prediction platform 102 may cause the categorization model to process the training sets by applying natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques.

In some examples, in training and/or otherwise configuring the categorization model to generate categorization predictions and/or predicted custom categories, the prediction platform 102 may cause the categorization model to store one or more correlations based on the one or more training sets. By causing the categorization model to store one or more correlations or otherwise learn from the training sets, the prediction platform 102 may train the categorization model to utilize techniques, keywords, confidence scores, and/or other features of the training sets to generate categorization predictions and/or predicted custom categories. For example, the prediction platform 102 may cause the categorization model to store correlations between two or more categories indicated by the training sets and use the stored correlations to generate new category names for files that do not correspond to any predefined categories. In this way, the prediction platform 102 may provide improvements over conventional categorization techniques by allowing for greater flexibility in file categorization. By using a large language model as the categorization model, the prediction platform 102 may additionally or alternatively provide the benefit of increasing the pool of information that the categorization model can draw from, and the amount of information that the categorization model can process, which will improve the accuracy of the categorization predictions and/or predicted custom categories generated by the prediction platform 102 as described further herein. It should be understood that, in some examples, the prediction platform 102 may alternatively utilize a pre-trained large language model to perform the steps described below, without performing the functions recited above at step 211. For example, the prediction platform 102 may utilize a pre-trained large language model but configure the large language model using prompt engineering, such as by providing prompts to guide the model in the form of clusters, embeddings, and/or clustered embeddings (e.g., as described below at steps 212-214).

In some examples, in training and/or otherwise configuring the categorization model, the prediction platform 102 may additionally or alternatively train and/or otherwise configure the categorization model to generate descriptions. For example, the prediction platform 102 may train and/or otherwise configure (e.g., using prompt engineering) the categorization model to generate file descriptions and/or cluster descriptions representing files that have been clustered by the prediction platform 102. In some examples, the prediction platform 102 may train and/or otherwise configure the categorization model to generate descriptions that pair with and/or otherwise correspond to categorization predictions as described herein. For example, the prediction platform 102 may train and/or otherwise configure the categorization model to generate and/or otherwise output, each time the categorization model generates a set of categorization predictions (e.g., based on input of a sample set of files) a description that is representative of the cluster from which the sample set of files were selected and/or that is representative of the sample set of files. In training and/or otherwise configuring the categorization model as described above the prediction platform 102 may, for example, provide an extended prompt to the categorization model. For example, during a prompt engineering process/session, the prediction platform 102 may provide an extended prompt by appending, to one or more prompts used to train and/or otherwise configure the categorization model to generate categorization predictions and/or predicted custom categories, a prompt to train/configure the categorization model to generate descriptions as described herein.

At step 212, the prediction platform 102 may generate a set of categorization predictions and/or one or more descriptions. In generating the set of categorization predictions, the prediction platform 102 may use the categorization model by inputting the sample set of files into the categorization model. A set of categorization predictions may include category names for each file of the sample set. The category names may correspond to categories that the categorization model predicts (e.g., using the one or more stored correlations and/or otherwise based on the training information used to train the categorization model, or based on providing the sample set of files as a prompt for the categorization model) will match to the information included in the sample files. For example, the set of categorization predictions for a sample set of three files may include three category names, with one category name for each file. Based on the use of the categorization model as described herein, the prediction platform 102 may generate a set of categorization predictions including category names that more accurately reflect the contents of the sample files than those category names that a conventional categorization technique might produce. For example, the sample set of files may include three invoices, but rather than applying a blanket OOB category name such as “invoice” to the files the prediction platform 102 may generate a set of categorization predictions including category names such as “marketing invoice,” “employee invoice,” or the like. The set of categorization predictions may represent a prediction of how the files included in the sample set would be categorized if the sample set of files was presented to a user. The category names included in the set of categorization predictions might not match any category names included in the plurality of predefined categories received at step 202.

Additionally or alternatively, in generating the one or more descriptions, the prediction platform 102 may generate one or more descriptions based on inputting the sample set of files into the categorization model. For example, based on inputting the sample set of files into the categorization model, the prediction platform 102 may cause the categorization model to generate descriptions corresponding to the sample set of files and/or corresponding to the cluster from which the sample set of files was collected. In some examples, the descriptions may be paired with, linked to, and/or otherwise associated with a set of categorization predictions generated simultaneously or near-simultaneously by the categorization model (e.g., as described above in this step). The description may provide additional relevant context to the cluster and/or to the sample set of files beyond the context provided by the category names included in the set of categorization predictions. For example, the prediction platform 102 may generate descriptions that correspond to the example category names “marketing invoice,” “employee invoice,” “third party invoice,” or the like. The descriptions may be and/or include sentences, keywords, or the like providing context as to how or why the categorization model generated those category names when generating the set of categorization predictions. For example, the categorization model may generate descriptions such as “marketing invoice identified as being for marketing of Project A,” “employee invoice identified as corresponding to an employee working on Project A,” “third party invoice identified as being associated with work on Project A,” and/or other descriptions.

Referring to FIG. 2D, at step 213, the prediction platform 102 may generate a summary category name. For example, the prediction platform 102 may generate a summary category name that summarizes the set of categorization predictions generated at step 212. The summary category name may summarize the category names of each sample file used to generate the set of categorization predictions into a single category name. For example, the summary category name for a set of categorization predictions comprising “marketing invoice, “employee invoice,” and “third party invoice” may be “project A invoices,” where project A is a project to which all three sample files are related. In this way, the prediction platform 102 may generate a summary category name that is different from the generic OOB category name and that more accurately reflects the contents of the sample files. It should be understood that this is one theoretical example and that other summary category names are contemplated by the present disclosure. In some examples, in generating the summary category name, the prediction platform 102 may utilize the categorization model. For example, the prediction platform 102 may provide the set of categorization predictions to the categorization model as an input (e.g., in a second call of the categorization model after utilizing the categorization model to generate the set of categorization predictions) to cause the categorization model to output the summary category name. It should be understood that, in some examples, steps 212 and 213 may be performed by the categorization model automatically (e.g., the summary category name may be generated after the categorization model generates the set of categorization predictions without additional prompting or user input). Additionally, in some examples, in generating the summary category name the prediction platform 102 may generate a description representing the cluster comprising the sample set of files (and also representing the sample set of files) used to generate the set of categorization predictions. The description may be and/or include one or more sentences, keywords, or the like. In generating the description, the prediction platform 102 may cause the categorization model (e.g., based on having previously trained and/or otherwise configured the categorization model) to identify one or more attributes, traits, or the like common to the sample set of files and/or corresponding to the summary category name. Additionally or alternatively, in some examples, the categorization model may generate the description based on one or more descriptions of sample files (e.g., descriptions generated by the categorization model previously, as described at step 212). In this way, the categorization model may generate a description that provides context to how and/or why the summary category name was generated to summarize the set of categorization predictions. For instance, returning to the example described above in this step, the prediction platform 102 may generate (e.g., using the categorization model) a description corresponding to the summary category name “Project A invoices,” where the description may be “invoices that were identified as being associated with development of Project A”. It should be understood that this is merely an example and that the descriptions may include more or less detail and/or may be formatted differently without departing from the scope of this disclosure.

At step 214, the prediction platform 102 may generate embeddings. The prediction platform 102 may generate embeddings based on the summary category name. For example, the prediction platform 102 may generate an embedding for the summary category name, producing an embedding that effectively summarizes each different categorization prediction included in the set of categorization predictions. In generating the embeddings, the prediction platform 102 may convert the summary category name into a format configured to be analyzed and clustered by the clustering algorithm. For example, the prediction platform 102 may vectorize the summary category name to convert the category names into a multidimensional vector representing the information included within the summary category name. In some examples, the prediction platform 102 may additionally generate embeddings based on one or more descriptions. For example, the prediction platform 102 may generate embeddings for a description corresponding to the summary category name (e.g., as described at step 213).

It should be understood that, based on generating the embeddings, certain steps described above may be repeated once or more in order to generate further summaries (and further corresponding embeddings). For example, the prediction platform 102 may repeat certain functions described above at step 208 to further cluster, based on the embeddings of the summaries of step 213 (e.g., using the clustering algorithm and as described above at step 208), clusters of files configured to be further analyzed by the categorization model. For example, the prediction platform 102 may generate a hierarchical clustering of the embeddings. A hierarchical clustering (such as that illustrated in FIG. 3) may be generated based on performing hierarchical aggregation of the embeddings such that, at escalating levels of the hierarchy, files and/or clusters of files from a previous level of the hierarchy are clustered together. The prediction platform 102 may additionally repeat the functions described at step 213 in order to produce additional summaries of category names based on the additional clusters generated by repeating step 208 as described above. For example, the prediction platform 102 may generate additional summaries of category names that summarize the clusters that were generated based on the embeddings of step 214.

At step 215, the prediction platform 102 may generate a predicted custom category. In generating the predicted custom category, the prediction platform 102 may provide, as input, the summaries of category names. For example, the prediction platform 102 may provide a plurality of summaries of category names generated using the techniques described above at step 213. In some examples, in providing the summaries of category names as input, the prediction platform 102 may provide the embeddings of the summaries of category names (e.g., the embeddings generated at step 214). The prediction platform 102 may cause the categorization model to generate the predicted custom category as an open question. For example, the prediction platform 102 may cause the categorization model to generate the predicted custom category based on the training information sets that the categorization model was previously trained upon, and on the prompts provided to the model (e.g., embeddings of the summaries of category names summarizing the set of categorization predictions and/or the clustered sample set of files), without forcing the categorization model to lock the prediction in to any particular preexisting category. In this way, the categorization model may generate a predicted custom category for the set of categorization predictions that is distinct from any out-of-the-box or predefined categories. The predicted custom category may be or include a custom category name that the categorization model determines to effectively represent the summaries of category names (e.g., the summaries of the set of categorization predictions and the other inconsistent files previously identified by the prediction platform 102). For example, if the prediction platform 102 previously generated embeddings representing summaries (e.g., summaries of category names generated as described at step 213) that included the category names “chemical analysis documents,” “electrochemical analysis documents,” and “material analysis documents,” the categorization model may generate a predicted custom category having a category name of “technical analysis documents” that effectively represents the summaries of category names based on the similarity of the files corresponding to the summaries of category names. For example, the predicted custom category may be generated based on determining, using the categorization model, that similarity of the files corresponding to the summaries of category names satisfies a threshold similarity (e.g., 40%, 50%, 60%, and/or other thresholds). The predicted custom category may provide a more accurate summary of sample files than a predefined category name is capable of providing, because the predicted custom category is based on the summaries of category names and is not limited to predefined out-of-the-box category names.

The generation of the predicted custom category may be substantially opaque to a user of the prediction platform 102 (e.g., an employee or customer of the entity that manages the prediction platform 102). The categorization model may utilize machine learning techniques that are opaque to the user to generate the predicted custom category. For example, in generating the predicted custom category, the prediction platform 102 may cause the categorization model to select the predicted custom category from among a set of candidate predicted custom categories and/or otherwise determine, using stored correlations, confidence scores, and/or other training data or prompts used to train or configure the categorization model, an optimal predicted custom category. For example, the categorization model may initially generate, using any machine learning technique available to a large language model such as the categorization model, a set of candidate predicted custom categories and identify a confidence score for each candidate predicted custom category. A confidence score may be an integer, decimal value, percentage, and/or any other mathematical representation of a likelihood that a respective candidate predicted custom category accurately summarizes the set of categorization predictions provided as input to the categorization model. In these examples, the categorization model may compare the confidence score for each candidate predicted custom category and select the candidate predicted custom category corresponding to the highest confidence score. Based on generating the predicted custom category, the prediction platform 102 may proceed to cause one or more policy updates to file categorization policies associated with the prediction platform 102. For example, the prediction platform 102 may proceed to step 216 to cause a security update, and/or may proceed to step 217 to cause an update to predefined categories.

In some examples, as part of and/or in addition to generating the predicted custom category, the prediction platform 102 may generate a description representing the predicted custom category. In this way, the prediction platform 102 may generate a description also representing the cluster of files from which the sample set or sets of files used to generate the categorization predictions that produced the predicted custom category (e.g., as described at steps 212-215 above) were selected. The description may be and/or include one or more sentences, keywords, or the like. The description may provide additional context and/or information for the files included in the cluster from which the sample set or sets of files were selected. For example, if the predicted custom category were “Rejected Invoices Non-matching SSNs,” the description generated by the prediction platform 102 may be and/or include sentences comprising a summary of attributes, traits, keywords, or the like associated with each sample file selected from the cluster such that the description provides context as to how and/or why the prediction platform 102 clustered the files together, how and/or why the prediction platform 102 selected the sample files from the cluster, how and/or why the prediction platform 102 generated the set of categorization predictions for the sample files, and/or how/why the prediction platform 102 performed other functions described herein (e.g., at steps 212-215). For example, a description generated for the “Rejected Invoices Non-matching SSNs” predicted custom category may be “invoices where the payment was rejected because the SSNs do not match,” providing context for what traits, features, attributes, or the like caused the prediction platform 102 to initially cluster the files selected as sample files together. Also or alternatively, in some examples, the description may include information identifying certain contents of the files. For example, the description may be and/or include a statement or the like identifying that the files in the cluster from which the sample sets of files were selected include private personal information (PPI) or personally identifiable information (PII), a statement or the like identifying which files in the cluster include PPI and/or PII, a statement or the like identifying a percentage of files in the cluster that include PPI and/or PII, a list or the like of all the PPI and/or PII included in the files, a list or the like of the PPI and/or PII that is included in only a subset of the files, and/or other statements, lists, or the like.

At step 216, the prediction platform 102 may perform a sensitivity assessment. For example, based on generating the predicted custom category (and/or based on generating a description corresponding to the predicted custom category) as described at step 215, the prediction platform 102 may perform a sensitivity assessment. In performing the sensitivity assessment, the prediction platform 102 may identify an amount (e.g., a number, a percentage, or the like) of sensitive information that is included in files in the cluster corresponding to the predicted custom category. For example, the prediction platform 102 may identify types of PPI/PII included in the files in the cluster, a percentage of files in the cluster that include PPI/PII, a percentage of PPI/PII in individual files of the cluster, and/or other indicates of the amount of sensitive information included in the files in the cluster. In some examples, in performing the sensitivity assessment, the prediction platform 102 may generate a sensitivity score. For example, the prediction platform 102 may use one or more algorithms, formulas, or the like to generate a sensitivity score representing how sensitive the cluster corresponding to the predicted custom category may be to cyberattacks, leaks, or the like. The sensitivity score may be generated using any number of parameters. For example, the sensitivity score may be generated based on determining a percentage of files, included in the cluster, that include PPI/PII. The sensitivity score may additionally or alternatively be generated based on assigning weights to one or more different types of PPI/PII included in the files in the cluster corresponding to the predicted custom category and, based on the assigned weights, determining the sensitivity score. For example, the sensitivity score may be generated using an algorithm such as:

Sensitivity Score=weight 1*(number of files with PPI type 1)+weight 2*(number of files with PPI type 2)+weight 3*(number of files with PPI type 3).

It should be understood that this is merely an example and that other parameters, algorithms, formulas, and/or the like may be used to generate the sensitivity score without departing from the scope of this disclosure.

Referring to FIG. 2E, at step 217, based on generating the predicted custom category, the prediction platform 102 may cause a security update. For example, the prediction platform 102 may cause one or more data loss prevention rules, and/or other cybersecurity rules, to be updated based on the predicted custom category. The security update may cause one or more security systems to perform security actions based on the predicted custom category. For example, the security update may update a packet processing rule to cause packets associated with the predicted custom category to be treated differently (e.g., blocked, or forwarded, depending on the security rule). In causing the security update, the prediction platform 102 may send the predicted custom category and/or one or more instructions to cause the security update to a security device. For example, the prediction platform 102 may send the predicted custom category and/or one or more instructions to the second device 106 to cause the second device 106 to implement, at or with other devices associated with the entity managing the second device 106, the security update. The prediction platform 102 may send the predicted custom category and/or one or more instructions via the communication interface 113 and while the second wireless data connection is established. Based on sending the predicted custom category to the second device 106, the prediction platform 102 may cause the second device 106 to update itself and/or may cause the second device 106 to propagate the security update to other devices (e.g., the first device 104, and/or other devices). In causing the security update, the prediction platform 102 may utilize the predicted custom category by causing the security update based on a single embedding, of a summary category name, that represents the entire predicted custom category. Additionally or alternatively, in causing the security update, the prediction platform 102 may utilize the predicted custom category by causing the security update based on a mean, average, or other summary of the aggregation of files associated with the predicted custom category. In some examples, in causing the security update, the prediction platform 102 may recommend security updates (e.g., to a user of the prediction platform 102). The recommended security updates may be and/or include suggestions of security rules to add to one or more security policies. The recommended security updates may be based on the predicted custom category and/or based on a description of the predicted custom category. The recommended security updates may additionally or alternatively be based on a sensitivity assessment (e.g., as performed by the prediction platform 102). For example, based on a sensitivity assessment indicating that the cluster associated with the predicted custom category includes sensitive information, and/or based on determining that a sensitivity score generated while performing the sensitivity assessment exceeds a threshold value, the prediction platform 102 may recommend a security update be made to one or more data loss prevention policies in order to improve security for the sensitive files. In causing the security update, the prediction platform 102 may improve: the security of the files associated with the predicted custom category, the security of the network 101, the security of individual devices (e.g., the first device 104, the second device 106, and/or other devices) and/or other aspects of system for providing improved security using large language models described herein.

At step 218, based on generating the predicted custom category, the prediction platform 102 may cause an update to a set of predefined categories. For example, the prediction platform 102 may output the predicted custom category to a device that manages/stores the predefined categories. For example, the prediction platform 102 may output the predicted custom category to the second device 106 via the communication interface 113 and while the second wireless data connection is established. Based on outputting the predicted custom category, the prediction platform 102 may cause the second device 106 to update a set of predefined categories stored at the second device 106 to include the predicted custom category. Accordingly, the second device 106 may provide the updated set of predefined categories to customers of the enterprise associated with the second device 106 such that the customers may utilize the predicted custom category. Additionally or alternatively, in some examples the prediction platform 102 may output the predicted custom category directly to a user device of a customer. For example, the prediction platform 102 may output the predicted custom category to the first device 104 via the communication interface 113 and while the first wireless data connection is established. Based on outputting the predicted custom category to the first device 104 the prediction platform 102 may cause the first device 104 to update a set of predefined custom categories to include the predicted custom category, allowing the user of the first device 104 to utilize the predicted custom category in file classification functions performed by the user of the first device 104. In some examples, based on outputting the predicted custom category, the prediction platform 102 may additionally cause updates to one or more existing category names. For example, a file previously classified using a category name from an out of box set of category names may be modified to have a category name corresponding to the predicted custom category. In updating the set of predefined categories, the prediction platform 102 may utilize the predicted custom category by causing the update based on a single embedding, of a summary category name, that represents the entire predicted custom category. Additionally or alternatively, in updating the set of predefined categories, the prediction platform 102 may utilize the predicted custom category by causing the update based on a mean, average, or other summary of the aggregation of files associated with the predicted custom category

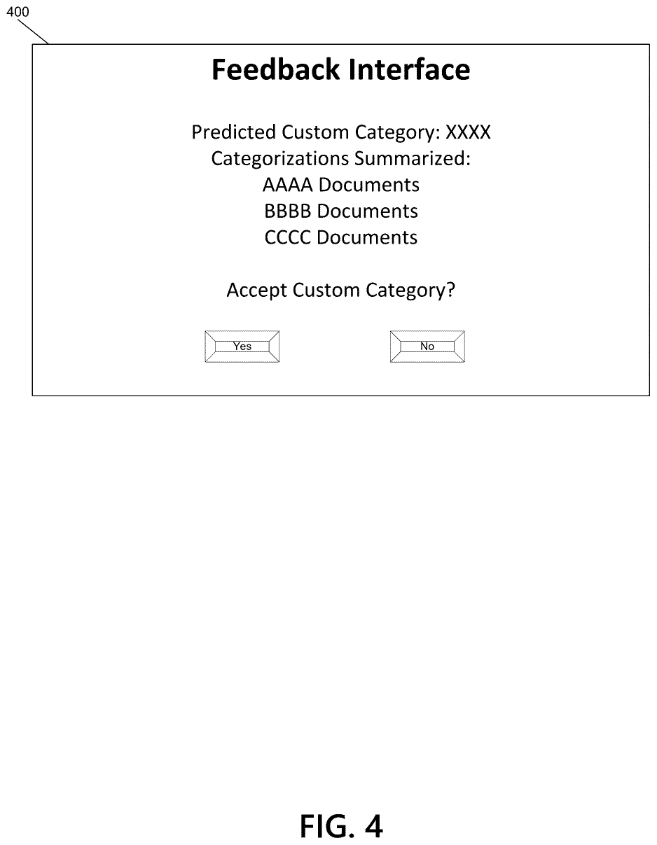

At step 219, based on and/or as part of causing an update to a policy (e.g., a security policy as described at step 217, or an update to a set of predefined categories as described at step 218), the prediction platform 102 may cause display of a user interface. For example, after or during the performance of either of steps 217 or 218, the prediction platform 102 may send one or more commands to the first device 104 and/or to the second device 106 to cause the first device 104 and/or the second device 106 to display a user interface. The prediction platform 102 may cause the display of the user interface in order to receive feedback based on the predicted custom category. In causing display of the user interface, the prediction platform 102 may cause display of a graphical user interface similar to feedback interface 400, which is illustrated in FIG. 4.

Referring to FIG. 4, in some instances, the feedback interface 400 may include information requesting the user of the first device 104 and/or the user of the second device 106 to provide feedback information. For example, the feedback interface 400 may include information such as a request for confirmation or acceptance of the predicted custom category, and/or other information. The feedback interface 400 may also display additional information related to the predicted custom category to facilitate the providing of feedback. For example, the feedback interface 400 may display information such as the predicted custom category, a list of the files summarized by the predicted custom category, and/or other information. The feedback interface 400 may also display interface elements or selectable options requesting user input. For example, the feedback interface 400 may display one or more of: an information entry field, a button or buttons, a toggle or toggles, a check box or boxes, and/or other interface elements. For example, as illustrated in FIG. 4, the interface elements may be one or more buttons the user might toggle or select to confirm or accept the predicted custom category. In these examples, the user input to the interface elements may be provided as feedback to the prediction platform 102 (e.g., as described at step 219).

Referring again to FIG. 2E, at step 220, the prediction platform 102 may receive feedback. For example, the prediction platform 102 may receive feedback related to the predicted custom category and from one or more user devices. The prediction platform 102 may receive feedback from the first device 104 (e.g., via the communication interface 113 and while the first wireless data connection is established), the second device 106 (e.g., via the communication interface 113 and while the second wireless data connection is established), and/or other devices based on output of the predicted custom category and/or based on causing display of the feedback interface. The feedback may include information indicating whether the predicted custom category was added to a set of predefined categories, information indicating whether the predicted custom category was used in a security update, and/or other information indicating acceptance or rejection of the predicted custom category.

Referring to FIG. 2F, at step 221, the prediction platform 102 may update the clustering algorithm. For example, the prediction platform 102 may update the clustering algorithm based on feedback received from one or more user devices. In updating the clustering algorithm, the prediction platform 102 may cause the clustering algorithm to refine, validate, and/or otherwise update itself using unsupervised machine learning techniques (e.g., principal component analysis, hierarchical clustering, K-means clustering, and/or other unsupervised techniques) to improve its accuracy. For example, the prediction platform 102 may provide feedback indicating that the predicted custom category was rejected, causing the clustering algorithm to update itself using unsupervised techniques to improve clustering and/or identification of inconsistent clusters performed by the clustering algorithm. In some examples, the clustering algorithm may not be updated, and the prediction platform 102 may proceed to step 222 without performing the functions described at step 221.

At step 222, the prediction platform 102 may update the categorization model. For example, the prediction platform 102 may update the categorization model based on feedback received by the prediction platform 102. In updating the categorization model, the prediction platform 102 may refine, validate, and/or otherwise update the categorization model to improve its performance of functions (e.g., generating categorization predictions, generating predicted custom categories, and/or other functions) described herein. For example, the prediction platform 102 may update the categorization model by providing additional training sets as input in response to the feedback received by the prediction platform 102. The categorization model may use machine learning techniques to modify its behaviors, algorithms, or the like based on the additional training sets. By inputting additional training sets based on feedback (e.g., feedback indicating that the predicted custom category was rejected), the prediction platform 102 may create and/or update an iterative feedback loop that may continuously and dynamically refine the categorization model to improve its accuracy in generating categorization predictions, generating predicted custom categories, and/or performing other functions. For example, the prediction platform 102 may cause the categorization model to store new correlations and/or update existing correlations based on the additional training sets such that the categorization model will utilize new information in generating future categorization predictions and/or predicted custom categories.

In updating the categorization model, the prediction platform 102 may improve the accuracy of the model for generating categorization predictions and/or predicted custom categories which may, for example, result in more efficient generating of predicted custom categories by the prediction platform 102 (and may in some instances, conserve computing and/or processing power/resources in doing so). The improvements to the accuracy of the model may also provide improvements to the security of the network 101 and/or devices connected to the network 101 by providing improved security updates as described herein.

Referring to FIG. 3, an example clustering 300 of embeddings of files is shown. The example clustering 300 may indicate which documents may be clustered together and one or more parameters of the clusters, such as a measure of the semantic distance between the clusters, indicating a threshold above which the documents will be clustered together. In FIG. 3, illustrating a potential hierarchical clustering of documents “Doc 1” through “Doc 10”, a first distance parameter 305 is a distance parameter indicating a threshold level of distance between documents, above which the prediction platform 102 may cause the clustering algorithm to indicate that the cluster exceeds the distance parameter 305. For example, as shown in FIG. 3, distance parameter 305 may be a value of approximately 0.25, indicating that files included in a cluster should have a similarity of, or exceeding, 0.75 (or 75%). Based on this example parameter 305, files “Doc 6” and “Doc 10” are semantically similar enough to satisfy the distance parameter 305 (and therefore will be clustered together), while the other illustrated potential clusters of files (e.g., a cluster 320 of “Doc 5” and “Doc 8”) do not satisfy the distance parameter 305 and will not be clustered together because the files in these potential clusters are not semantically similar enough. It should be understood that distance parameter 305 is merely an example distance parameter and that other parameters are within the scope of this disclosure. For instance, distance parameter 315, also shown in FIG. 3, is another distance parameter which indicates that files will be clustered together if the semantic distance between the files is less than 0.8. For example, “Doc 5” and “Doc 8” would be in a cluster 320, along with “Doc 6” and “Doc 10” from cluster 310, if the threshold level of distance is 0.8 or greater, as indicated by distance parameter 315. It should be understood that example clustering 300 is but one example of a hierarchical representation of clusters generated by the prediction platform 102 and that other parameters, files, and representations are within the scope of this disclosure.

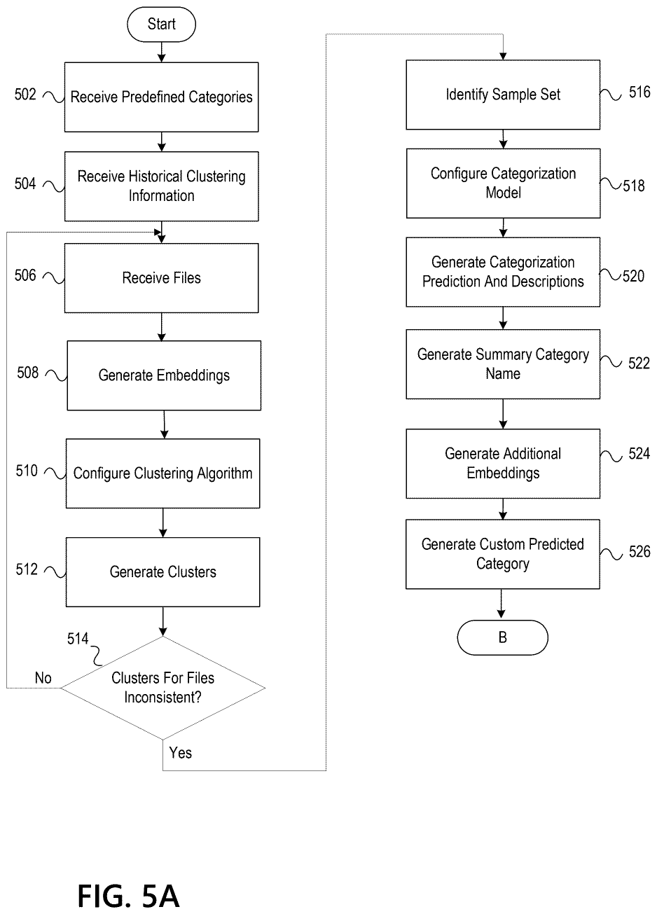

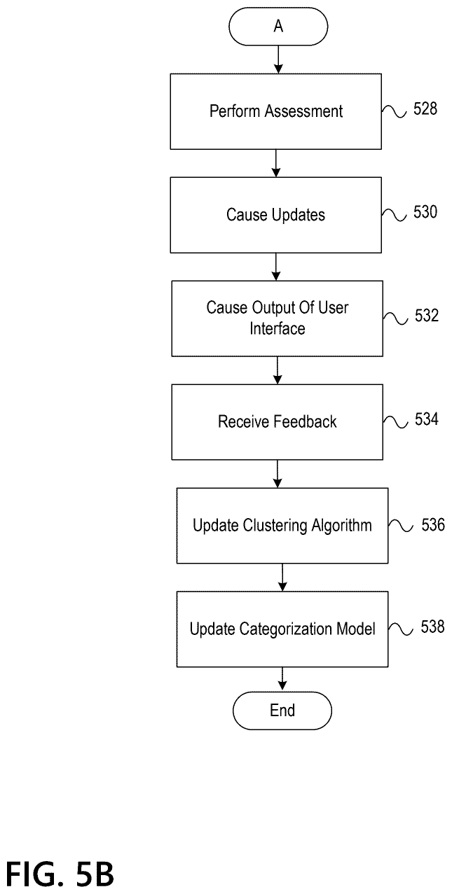

FIGS. 5A-5B depict an illustrative method for providing improved file security using large language models in accordance with one or more example arrangements. Referring to FIG. 5A, at step 502, a computing platform having at least one processor, a communication interface, and memory may receive predefined categories of files. At step 504, the computing platform may receive historical clustering information. The historical clustering information may comprise embeddings of historically clustered/classified files. At step 506, the computing platform may receive files. For example, the computing platform may receive files as an additional training set for a clustering algorithm. At step 508, the computing platform may generate embeddings of the files. At step 510, the computing platform may configure a clustering algorithm. For example, the computing platform may train, based on the historical information and/or based on the generated clusters of files, a clustering algorithm to perform unsupervised clustering of files. At step 512, the computing platform may generate clusters of files. At step 514, the computing platform may identify whether there are any inconsistently classified files within the clusters of files generated by the clustering algorithm. Based on identifying that there are no inconsistent clusters of files, the computing platform may return to step 506 and receive additional files (e.g., for additional training of the clustering algorithm). Based on identifying at least one inconsistent cluster of files, the computing platform may proceed to step 516 and identify a sample set of files. For example, the computing platform may identify the sample set of files based on any identified inconsistent files.

At step 518, the computing platform may configure a categorization model. For example, the computing platform may configure a large language model to generate categorization predictions and custom predicted categories. At step 520, the computing platform may generate categorization predictions and descriptions. For example, the computing platform may generate categorization predictions for the sample set of files based on inputting the sample set of files into the categorization model. The computing platform may also or alternatively generate predictions for the sample set of files and corresponding to the categorization predictions. At step 522, the computing platform may generate summary category names. For example, the computing platform may generate a summary category name for the categorization predictions. In some examples, in generating the summary category names, the computing platform may also generate a description. At step 524, the computing platform may generate additional embeddings. In generating the additional embeddings, the computing platform may cluster the embeddings of summary category names generated at step 522. At step 526, the computing platform may generate a predicted custom category. For example, the computing platform may generate a predicted custom category based on inputting the additional embeddings into the categorization model. In some examples, in generating the predicted custom category, the computing platform may also generate a description corresponding to the predicted custom category.

Referring to FIG. 5B, at step 528, the computing platform may perform an assessment. For example, the computing platform may perform a sensitivity assessment. At step 530, the computing platform may cause updates. For example, the computing platform may cause policy updates such as security updates, updates to predefined categories, and/or other updates. At step 532, the computing platform may cause output of a user interface. At step 534, the computing platform may receive feedback. For example, the computing platform may receive feedback relating to the predicted custom category. At step 536, the computing platform may update the clustering algorithm. At step 538, the computing platform may update the categorization model.

One or more aspects of the disclosure may be embodied in computer-usable data or computer-executable instructions, such as in one or more program modules, executed by one or more computers or other platforms to perform the operations described herein. Generally, program modules include routines, programs, objects, components, data structures, and the like that perform particular operations or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, configure the computing platform to:
receive historical clustering information and a plurality of predefined file categories;
configure, based on embeddings associated with the historical clustering information, a clustering algorithm to perform unsupervised clustering of files;
identify a sample set of files;
generate, using a plurality of embeddings of the sample set of files and the clustering algorithm, one or more clusters of files;
generate, based on the one or more clusters of files, a predicted custom category, wherein the predicted custom category comprises a category name summarizing the one or more clusters of files; and
output the predicted custom category.

2. The computing platform of claim 1, wherein the memory stores additional computer-readable instructions that, when executed by the at least one processor, configure the computing platform to:
configure a categorization model, wherein configuring the categorization model comprises:
providing, to the categorization model, one or more training sets of information corresponding to file categorization; and
causing, based on the one or more training sets, the categorization model to categorize files using at least one category name different from the plurality of predefined file categories,
wherein the categorization model is used to generate the predicted custom category, and
wherein the categorization model comprises a large language model.

3. The computing platform of claim 1, wherein the instructions, when executed by the at least one processor, configure the computing platform to cause one or more policy updates by:
outputting, to a security device, the predicted custom category,
wherein the outputting the predicted custom category causes the security device to update one or more data loss prevention cybersecurity rules.

4. The computing platform of claim 3, wherein the instructions, when executed by the at least one processor, configure the computing platform to cause the one or more policy updates by causing, based on the output of the predicted custom category, one or more devices to update the plurality of predefined file categories to include the predicted custom category.

5. The computing platform of claim 1, wherein the memory stores additional computer-readable instructions that, when executed by the at least one processor, configure the computing platform to:
receive, based on the output of the predicted custom category and from one or more devices, feedback information corresponding to the predicted custom category; and
update, based on the feedback information, one or more of:
the clustering algorithm; and
a categorization model.

6. The computing platform of claim 5, wherein the memory stores additional computer-readable instructions that, when executed by the at least one processor, configure the computing platform to:
cause, based on the output of the predicted custom category, display of a feedback interface,
wherein the feedback information is based on user input responsive to the display of the feedback interface.

7. The computing platform of claim 1, wherein the configuring the clustering algorithm comprises providing the clustering algorithm with:
a cluster size parameter defining a minimum cluster size and a maximum cluster size; and
a distance parameter, wherein the distance parameter comprises a maximum semantic difference allowed between any two files to be clustered together by the clustering algorithm.

8. The computing platform of claim 1, wherein the memory stores additional computer-readable instructions that, when executed by the at least one processor, configure the computing platform to:
identify, based on the historical clustering information, one or more inconsistent clusters,
wherein the sample set of files is based on the one or more inconsistent clusters.

9. The computing platform of claim 1, wherein the instructions, when executed by the at least one processor, configure the computing platform to generate the one or more clusters of files by:
generating, based on inputting the plurality of embeddings into the clustering algorithm, a set of categorization predictions, wherein each categorization prediction comprises a category name for a corresponding file of the sample set of files; and
clustering, based on performing hierarchical aggregation and based on the set of categorization predictions, files of the sample set of files into the one or more clusters.

10. The computing platform of claim 1, wherein the instructions, when executed by the at least one processor, further configure the computing platform to:
generate, using a categorization model, a description corresponding to the predicted custom category; and
output the description.

11. A method comprising:
at a computing platform comprising at least one processor, a communication interface, and memory:
receiving historical clustering information and a plurality of predefined file categories;
configuring, based on embeddings associated with the historical clustering information, a clustering algorithm to perform unsupervised clustering of files;
identifying a sample set of files;
generating, using a plurality of embeddings of the sample set of files and the clustering algorithm, one or more clusters of files;
generating, based on the one or more clusters of files, a predicted custom category, wherein the predicted custom category comprises a category name summarizing the one or more clusters of files; and
outputting the predicted custom category.

12. The method of claim 11, further comprising:
configuring a categorization model, wherein configuring the categorization model comprises:
providing, to the categorization model, one or more training sets of information corresponding to file categorization; and
causing, based on the one or more training sets, the categorization model to categorize files using at least one category name different from the plurality of predefined file categories,
wherein the categorization model is used to generate the predicted custom category, and
wherein the categorization model comprises a large language model.

13. The method of claim 11, further comprising causing one or more policy updates by:
outputting, to a security device, the predicted custom category,
wherein the outputting the predicted custom category causes the security device to update one or more data loss prevention cybersecurity rules.

14. The method of claim 13, wherein the causing the one or more policy updates comprises causing, based on the output of the predicted custom category, one or more devices to update the plurality of predefined file categories to include the predicted custom category.

15. The method of claim 11, further comprising:
receiving, based on the output of the predicted custom category and from one or more devices, feedback information corresponding to the predicted custom category; and
updating, based on the feedback information, one or more of:
the clustering algorithm; and
a categorization model.

16. The method of claim 15, further comprising:
causing, based on the output of the predicted custom category, display of a feedback interface,
wherein the receiving the feedback information is based on user input responsive to the display of the feedback interface.

17. The method of claim 11, wherein the configuring the clustering algorithm comprises providing the clustering algorithm with:
a cluster size parameter defining a minimum cluster size and a maximum cluster size; and
a distance parameter, wherein the distance parameter comprises a maximum semantic difference allowed between any two files to be clustered together by the clustering algorithm.

18. The method of claim 11, further comprising:
identifying, based on the historical clustering information, one or more inconsistent clusters,
wherein the identifying the sample set of files is further based on the one or more inconsistent clusters.

19. The method of claim 11, wherein the generating the one or more clusters of files comprises:
generating, based on inputting the plurality of embeddings into the clustering algorithm, a set of categorization predictions, wherein each categorization prediction comprises a category name for a corresponding file of the sample set of files; and
clustering, based on performing hierarchical aggregation and based on the set of categorization predictions, files of the sample set of files into the one or more clusters.

20. One or more non-transitory computer-readable media storing instructions that, when executed by a computing platform comprising at least one processor, a communication interface, and memory, cause the computing platform to:
receive historical clustering information and a plurality of predefined file categories;
configure, based on embeddings associated with the historical clustering information, a clustering algorithm to perform unsupervised clustering of files;
identify a sample set of files;
generate, using a plurality of embeddings of the sample set of files and the clustering algorithm, one or more clusters of files;
generate, based on the one or more clusters of files, a predicted custom category, wherein the predicted custom category comprises a category name summarizing the one or more clusters of files; and
output the predicted custom category.
